(19) United States
(12) Patent Application Publication
(10) Pub. No.: US 2025/0086400 A1
(43) Pub. Date: Mar. 13, 2025

(54) CONVERSATIONAL FEEDBACK SYSTEM

(71) Applicant: Ansel Blakeslee Duff, New York, NY (US)

(72) Inventor: Ansel Blakeslee Duff, New York, NY (US)

(21) Appl. No.: 18/830,563

(22) Filed: Sep. 10, 2024

Related U.S. Application Data
(60) Provisional application No. 63/582,183, filed on Sep. 12, 2023.

(51) Int. Cl. G06F 40/35; G06F 40/205; G06Q 10/105

(52) U.S. Cl. CPC G06F 40/35; G06F 40/205; G06Q 10/105

(57) ABSTRACT

The present invention comprises systems and methods for collecting, delivering, and analyzing user-initiated feedback. Embodiments of the feedback system can process unsolicited, unstructured user feedback from a variety of endpoints, including common electronic communication media (like email, SMS text messaging, or popular communication applications published by Slack Technologies, LLC and Microsoft Corp., for example). Users can initiate sharing unstructured feedback by sending a free-form message to an address or inbox that's affiliated with the feedback system. To enable the processing of unstructured feedback, the present invention contains novel methods for analyzing and remedying any issues with the incoming feedback submission through a conversational interaction between the feedback system and the submitting user. Additionally, embodiments of the system allow users to initiate feedback without first requiring a user or an organization (such as a user's employer) to first register to use the system.

### RELATED APPLICATIONS

This application claims priority based on a provisional patent application entitled METHODS AND SYSTEMS FOR COLLECTING, DELIVERING AND ANALYZING USER-INITIATED FEEDBACK, Ser. No. 63/582,183 filed on Sep. 12, 2023.

### GOVERNMENT FUNDS

No government funds were used to create this invention.

### FIELD OF THE INVENTION

The present invention relates to systems and methods for handling user-initiated feedback. More specifically, the invention relates to novel methods and systems that enable employees to initiate “real-time” feedback in a conversational dialogue and without limitations imposed by traditional surveys.

### BACKGROUND

In the modern workplace, timely feedback is a critical component to keeping employees engaged in their work. Findings from academics and commercial research organizations make it clear that frequent and continuous positive recognition helps motivate employees. Additionally, the sharing of constructive or critical feedback allows employees to feel heard and it also allows managers and employers to become aware of issues that may result in adverse outcomes for the organization and its employees. However, despite the critical need for timely, frequent, and continuous feedback, the employee engagement and feedback tools available today make it difficult or impossible for any employee to share open-ended, real-time feedback with their colleagues, managers, and organizations.

The available tools and systems available today for sharing feedback at work complicate and limit the transmission of feedback, both explicitly (e.g. by the structure or instructions of the systems) or implicitly (e.g. by limitations of features). For example, feedback systems are commonly employer-initiated (like with an employer-initiated survey), restricting an employee from sharing feedback outside of an open survey window. Other common limitations include restrictions around the style and content of the feedback, such as limiting the hierarchical direction of the feedback (such as requiring the feedback to come from an employee's manager), limiting the style (such as forcing feedback to be affirmative and/or complimentary), or by limiting the content by forcing survey respondents to answer a list of set prompts and thereby prohibiting a professional from giving feedback that doesn't directly relate to pre-set question. Lastly, a fundamental restriction of all workplace feedback systems available today is that in order for an employee to interact with these systems, that employee must be registered to use such system, either by the employee themself or by their organization (or both). This limitation precludes a professional from sharing feedback using such system until the employee and/or their organization has registered to use the system. Said differently, if a given organization has not registered to use or purchased the rights to use a given feedback system, that system's tools are of no use and no value to all employees of that organization.

One example of a feedback analysis method can be seen in US Patent No. US 2012/0311047 A1 filed on May 31, 2011 by Yokoi et al. which describes a method for associating an electronic message with an employee's performance management record. Such method described in this patent applies to associating an existing communication (like an email) with a performance record, but it does not contemplate ingesting freeform feedback to create a system record in the first place. For example, the method described in Yokoi et al.'s patent does not provide a system or method to ingest unsolicited, free-form feedback from a user and interact with the submitting user in such a manner than can correct any issues with the submission (such as incompleteness, for example). Additionally, the method described by Yokoi et al. requires their proposed system be embedded within an organization's framework (such as in the form of installing a software application onto one's computer, for example) and therefore their proposed system does not apply until the system has been acquired or installed (either by an employee and/or by their employer, for example).

Another example of a feedback system can be seen in US Patent application No. US 2012/0216130 A1 filed on Sep. 30, 2011 by Porro et al. which describes an interface for receiving, requesting, and displaying feedback in the form of an enterprise social network. The interface described by Porro et al. is subject to certain restrictions that limit employees' ability to share freeform feedback. For example, the interface of Porro et al. does not contemplate the ability for employees to share private, anonymous feedback. Additionally, Porro et al.'s interface does not have a system to remedy problematic feedback (such as incomplete feedback). Furthermore, use of the system and interface described by Porro et al. is restricted to users and employees that have subscribed to or signed up for such system (either on their own or on their behalf by their organization), rendering such interface inaccessible to employees that have not signed up to or purchased the rights to use such system (for whatever reason).

Another example of a feedback system can be seen in US Patent application No. US 2015/0242796 A1 filed on Feb. 25, 2015 by Hilton et al. which describes an email plugin that identifies user emails containing recognition-related feedback and directs those emails to a pre-determined mailbox. The invention described by Hilton et al. does not contain the functionality to accommodate a scenario where the feedback identified by the system is problematic for any reason. For example, the system in Hilton et al.'s application cannot interact with the user to remedy incomplete feedback as identified by the system. Furthermore, the system in Hilton et al.'s application is incapable of processing diverse types of feedback, including employee feedback that is not categorized as ‘recognition’ in nature. Additionally, the system described by Hilton et al. is incapable of handling, collecting, and delivering anonymous feedback from an employee to a recipient (such as feedback delivered by an employee where the contribution of such feedback is enabled because the employee feels comfortable providing feedback under the protection of anonymity).

Another example of a feedback analysis method can be seen in U.S. Pat. No. 11,227,112 B2 filed on Dec. 18, 2018 by Perumala et al. which describes a method for parsing communications for the purposes of employee feedback and engagement by identifying a user who contributed to a project or desired outcome. While this patent belonging to Perumala et al. includes a method to parse text feedback content to identify a ‘contributor’ within an organization, it does not contemplate a system or a method to systematically collect and analyze open-ended, free-form feedback. For example, this patent belonging to Perumala et al. describes a system that is unable interact with a user to correct an incomplete feedback submission. Additionally, the system described by Perumala et al. does not apply to feedback submissions that are not interpersonal in nature, where the nature of the feedback submission does not involve a “contributor” and/or a “decision maker” (such as an employee submitting a complaint about their computer being slow, for example).

Aside from the invention proposed herein, there doesn't exist any feedback systems that allow any employee to share feedback easily, quickly, and in a free-form or open-ended fashion. Specifically, none of the commercially-available employee engagement solutions or inventions referenced above provide an employee feedback system that: (i) lets an employee share feedback without the employee first signing up for the service that handles the feedback; (ii) lets an employee share feedback without the organization first signing up for the service that handles the feedback; (iii) lets an employee initiate open-ended and free-form feedback anonymously at any time; (iv) allows an employee to share feedback by initiating an unstructured, conversational interaction with the feedback system (such as in an email or a text message, for example); (v) includes a method of remedying potential issues in the feedback by way of the system responding to a user's unstructured feedback in a real-time, synchronous dialogue between the system and the user and with the system providing instructions to the user for actions that are needed for the user to undertake to finalize and correct their submission; (vi) provides the ability for employees to interact with feedback that's been given to others; (vii) allows an employee to share feedback about somebody that's employed by or affiliated with a different organization; and (viii) providers managers and human resources professionals with an interface for interacting with structured and unstructured feedback. What is needed, therefore, is an employee engagement and feedback solution that overcomes the above-mentioned limitations and that includes the features enumerated in the prior sentence.

### BRIEF SUMMARY OF THE INVENTION

The present invention comprises systems and methods that allow an employee to initiate feedback by using an intuitive, employee-initiated system. Embodiments of the present invention comprise a feedback system that is accessible by any employee, regardless of whether said employee has registered with the system of the present invention and regardless of whether said employee's organization has registered with the system of the present invention. Additionally, preferred embodiments of the present invention allow any employee to initiate sharing unstructured feedback with the feedback system through commonly-used electronic messaging applications and media (such as email, SMS text messaging, or through popular messaging applications published by Slack Technologies, LLC and Microsoft Corp., for example).

To allow for this conversational feedback interaction, embodiments of the present invention contain a novel method for processing unstructured feedback and correcting any issues identified with said feedback in a corrective conversational interaction between the submitting user and the feedback system. Certain embodiments of this corrective interaction between the feedback system and a submitting user are enabled by natural language processing (NLP) and artificial intelligence (AI) technologies. Certain embodiments of this feedback system of the present invention also offer employees the ability to share feedback anonymously, which offers several benefits to a submitting employee. Embodiments of the feedback system also allow submitted feedback to be made accessible in a graphical user interface that presents employees, managers, and human resources professionals with the ability to review, modify, and analyze feedback.

By enabling user-initiated (unsolicited) feedback submissions in a conversational format, preferred embodiments of the present invention offer several important benefits to employees and organizations alike when compared against traditional organization-led surveys, namely: i.) the ability for employees to submit feedback in real time without needing to wait for a survey to be initiated by their organization; ii.) the ability to share feedback within communication applications that an employee may already use and therefore preventing the need to download an additional software application to submit feedback; and iii.) allowing employees to submit important feedback privately and anonymously to their organization where such feedback submission may be otherwise inaccessible if the feedback's relevant topics are not explicitly prompted or asked by an organization in a traditional survey or if anonymous feedback submissions are otherwise inaccessible.

### BRIEF DESCRIPTION OF THE DRAWINGS

Some embodiments of the present invention are illustrated in this document as an example and are not limited by the figures of the accompanying drawings, in which like references make indicate similar elements and in which:

FIG. 1: FIG. 1 depicts a system that receives feedback from a variety of network-enabled endpoints in accordance with one embodiment of the present invention.

FIG. 2: FIG. 2 shows a flow diagram of method 200 of one embodiment of the present invention where such method 200 shows how a single system is capable of receiving structured and unstructured feedback.

FIG. 3: FIG. 3 shows a flow diagram of method 300 of one embodiment of the present invention where such method 300 shows how the feedback system extracts usable feedback from unstructured feedback.

FIG. 4: FIG. 4 shows a flow diagram of method 400 of one embodiment of the present invention where such method 400 shows how the feedback system can internalize usable feedback.

FIG. 5: FIG. 5 depicts a first example of a user interface display screen for one embodiment of the present invention, with such screen providing orienting text to the user around the feedback sharing process.

FIG. 6: FIG. 6 depicts a second example of a user interface display screen for one embodiment of the present invention, with such screen prompting a user for feedback input.

FIG. 7: FIG. 7 depicts a third example of a user interface display screen for one embodiment of the present invention, with such screen aggregating feedback about an individual.

FIG. 8: FIG. 8 depicts a fourth example of a user interface display screen for one embodiment of the present invention, with such screen providing analytical information to a user about feedback shared within a group.

FIG. 9: FIG. 9 depicts a first example dialogue for one embodiment of the present invention, with such dialogue showing an example of a user-initiated interaction with the feedback system where the user initiates the sharing of unstructured feedback.

FIG. 10: FIG. 10 depicts a second example dialogue for one embodiment of the present invention, with such dialogue showing an example of a user-initiated interaction with the feedback system where the user initiates the sharing of incomplete, unstructured feedback and system responds to the user in order to arrive at a usable feedback submission.

FIG. 11: FIG. 11 depicts first and second example outputs in one embodiment of the present invention with such examples related to two illustrative submissions of unstructured feedback.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. Furthermore, the methods described in the present disclosure each include multiple sequential steps. The steps (and their associated order) described in the accompanying figures and disclosure can be re-arranged in one or multiple different sequential orders and still achieve substantially the same end result as described in this disclosure. Additionally, it's possible that removing one or multiple steps from the methods described in the present disclosure can achieve substantially the same end results as described herein. Consequently, the present invention includes the associated permutations of the accompanying methods wherein a re-ordering and/or removal of one or multiple steps from a given method results in substantially the same end result as described herein.

As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

While embodiments are discussed herein with respect to a feedback handling application, embodiments are not limited thereto. For example, feedback handling and analysis methods discussed herein may be employed in various applications other than enterprise feedback applications, where improved ability to ingest, rectify, analyze, and respond to unstructured and unsolicited content is desired.

Furthermore, for the purposes of the present discussion, an organization may be a group of persons, such as a business, university, school, government, military, and so on. The terms “organization” and “employer” are used interchangeably herein. Personnel of an organization, i.e., organization personnel, may include any persons associated with the organization, such as employees, contractors, board members, advisors, students, teachers, professors, and so on. The terms “employee” or “employees” are used interchangeably herein. For example, an employee may be any person associated with an organization, such as a worker, manager, student, teacher, executive, contractor, advisor, or other person who may be able to contribute feedback relevant to the organization and/or its operations.

For the purposes of the present discussion, feedback is considered to be a type of information which includes any information or input regarding the performance of one or more tasks, behaviors, etc. Feedback may be come in a variety of forms including recognition, praise, critique, complaint, concern, constructive feedback, etc. Feedback can include, for example, advice given to a person (e.g., an employee) pertaining to a particular task, comments pertaining to a particular competency, input pertaining to tasks associated with a certain goal, advice pertaining to future or past performance, goals, aspirations, and so on.

A feedback message may be any message, such as an electronic message, which includes feedback information, or which is otherwise designated as constituting feedback. Hence, a feedback message may include advice, criticism, praise, instruction, and/or other input pertaining to a task, behavior, or other activity performed by a recipient of the feedback. For example, a manager may send a feedback message to a subordinate employee praising the employee for success in achieving a particular goal. A mentor may provide an instructional feedback message commenting as to how a particular mentee may improve performance pertaining to a particular task, and so on. The term “feedback” as used herein applies broadly to feedback shared in response to the operations or performance of an organization and/or its associated personnel. The terms “feedback,” “feedback content” and “feedback message” are used interchangeably herein.

The present disclosure distinguishes between structured and unstructured feedback as it pertains to embodiments of the present invention. For the purposes of this discussion, structured feedback refers to feedback that fits a pre-established format or template. For example, if a user fills out a form on a web page, the resulting content arising from that form submission would be considered structured feedback for the purposes of this discussion. In that scenario, the user would be responding to pre-defined questions and prompts, and the act of submitting feedback through the form organizes the user's responses into defined fields. Conversely, unstructured feedback does not readily fit into a pre-established format or template. For example, if a user were to send a free-form text communication (such as an email or text message) containing feedback, the content of that user's free-form text communication would be unstructured feedback since it wasn't submitted in an organized form or template. In the case of unstructured feedback, embodiments of the present invention include systems and methods for handling this unstructured feedback in ways that produce useable content for the feedback handling system of the present invention, all in a way that's fast and intuitive for the end user submitting the feedback.

Additionally, the present disclosure also distinguishes between solicited and unsolicited feedback. For the purposes of this discussion, solicited feedback refers to feedback that a user submits in response to a request or an instruction to do so. For example, completing a survey is an example of providing solicited feedback. Conversely, unsolicited feedback refers to feedback that is not shared in direct response to a request to share feedback. For example, if a user submits feedback to the feedback system of the present invention without having been instructed to do so beforehand, the feedback that they've submitted would be considered unsolicited feedback. For the purposes of this discussion, the terms “user-initiated” and “unsolicited” are used interchangeably. Traditionally, organizations have largely focused on collecting solicited feedback from employees. Consequently, there is a lack of options for collecting unsolicited feedback in an intuitive system that organizes, records, and analyzes this unsolicited feedback. This inadequacy of today's available feedback handling systems is a motivation for the creation of the present invention.

The present invention will now be described by referencing the appended figures representing examples of preferred embodiments.

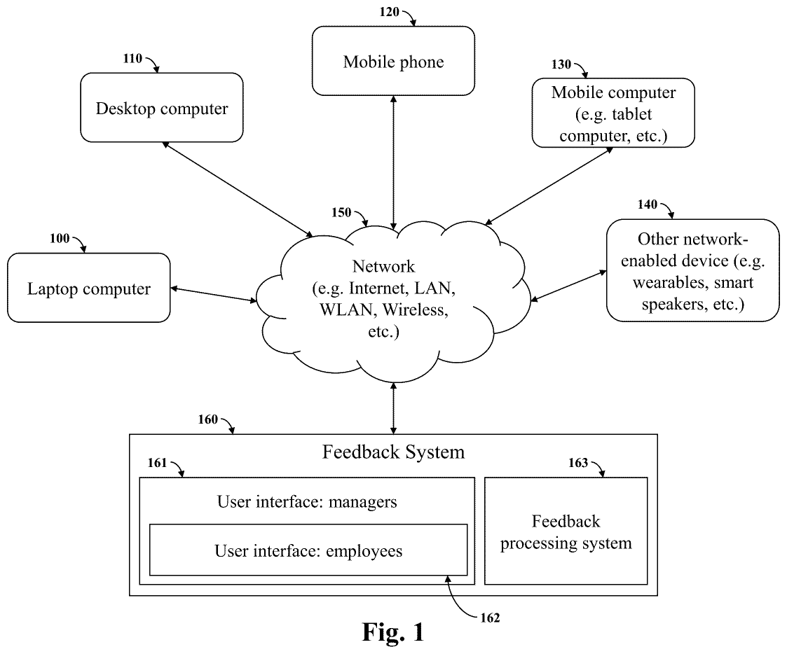

FIG. 1 depicts a schematic diagram of one illustrative embodiment of a feedback handling system 160. In this diagram, a feedback handling system 160 is connected to a network 150, such as the Internet. This network 150 in turn allows the feedback system 160 to interact with a variety of network-enabled devices 100-140. Ultimately, an end user utilizes these network-enabled devices to interact with the feedback system 160 through the network 150. Such user interactions can include submitting feedback, engaging in an interaction with the system to rectify a feedback submission, and/or using the system's user interfaces to view, edit, remove, and analyze feedback that's stored within the feedback system 160.

In one embodiment, these network-enabled devices can include a laptop computer 100, a desktop computer 110, a mobile phone 120, a mobile computer (such as a tablet computer) 130, and other network-enabled devices (such as wearable devices, internet-of-things (IoT) devices, etc.) 140. While these network-enabled devices 100-140 are displayed in FIG. 1 in one embodiment of the present invention, it's worth noting that the feedback system 160 is capable of interacting with countless network-enabled devices, including devices not explicitly listed in this figure.

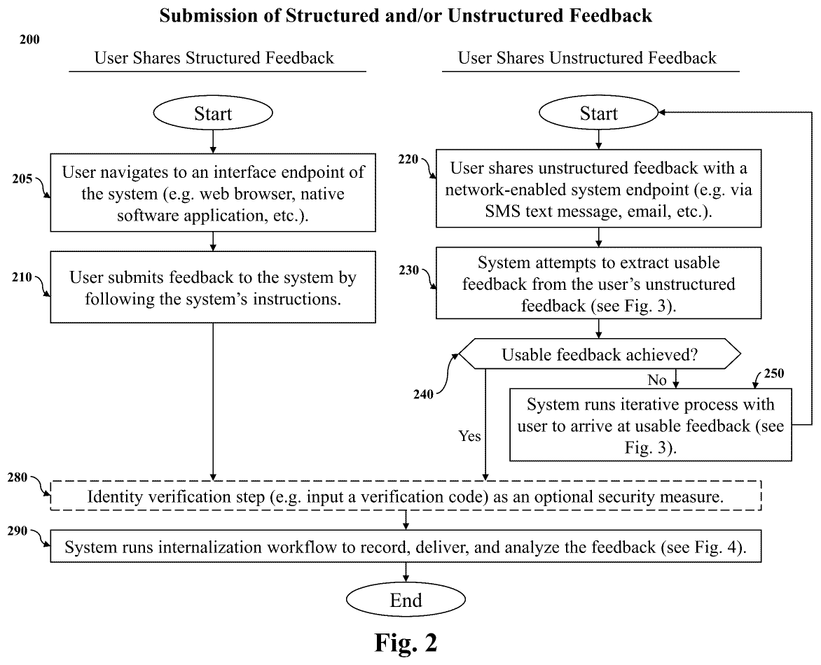

In one preferred embodiment, an end user can utilize a network-enabled device to interact with the feedback system 160 through multiple methods. For example, an end user can submit structured feedback to the feedback system 160 through a user interface 161 and/or 162, whereby the end user would follow the user interface's instructions to submit feedback according to a set of expected inputs. Additionally, an end user could also utilize a network-enabled device to submit unstructured feedback to the feedback system 160 by initiating an unsolicited, free-unstructured communication such as a text message, an email message, or a chatbot message (such as through communication applications like Slack (a communication application published by Slack Technologies, LLC) and/or Microsoft Teams (a communication application published by Microsoft Corporation)). In a preferred embodiment, both structured and unstructured feedback can be submitted through the same network-enabled devices 100-140 and all feedback can be ultimately handled through a singular, centralized feedback system 160. Such centralization of structured and unstructured feedback is further explored in FIG. 2.

In one embodiment, the feedback system 160 includes a user interface for employees 162, a user interface for managers (which can include human resources professionals) 161, and a feedback processing system 163. In one preferred embodiment, the user interface for managers 161 includes additional functionality that is not accessible by non-managerial employees in the employee user interface 162.

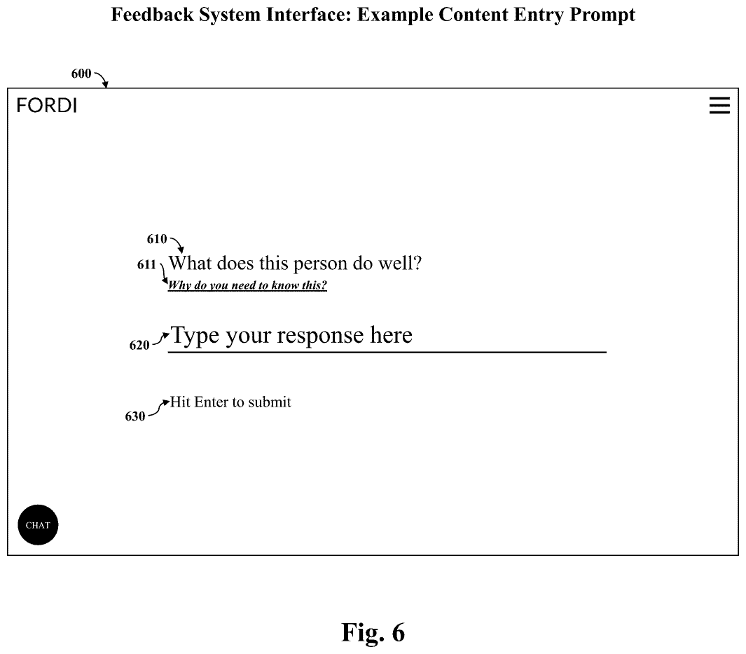

In one embodiment, the feedback processing system 163 is a network-enabled application system that handles, stores, processes, parses, and analyzes feedback. For clarity of the present disclosure, certain well-known components of a computer application system, such as servers, hard drives, processors, operating systems, power supplies, and so on, have been omitted from both FIG. 1 and other figures herein. However, those skilled in the art with access to the present teachings will know which components to implement and how to implement them to meet the needs of a given application without undue experimentation. Furthermore, the functionality and methods of the feedback processing 160 are further explained in the ensuing FIGS. 2-5 and operative examples are further described in FIGS. 6-11.

The present disclosure describes processes for receiving feedback through network-enabled endpoints. The term “endpoint” as used herein refers to a medium through which a submitting user can submit feedback electronically. Examples of network-enabled endpoints include user interfaces accessible by a web browser, user interfaces accessible through a native (installed) software application, user interfaces accessible through a mobile application, Short Message Service (SMS) text messaging, Multimedia Messaging Service (MMS) text messaging, electronic mail (email) messaging, audio phone calls, messaging handled in Slack (a communication application published by Slack Technologies, LLC), messaging handled in Microsoft Teams (a communication application published by Microsoft Corporation), messaging handled in Discord (a communication application published by Discord Inc.) and/or an interaction with a chatbot. The devices 100-140 are each capable of accessing the feedback system 160 through at least one network-enabled endpoint. In one preferred embodiment, devices 100-130 can access the feedback system 160 through multiple network-enabled endpoints. For example, a mobile phone 120 can access the feedback system 160 through a web browser on the mobile phone, through email messaging, through SMS text messaging, through MMS text messaging, through Slack, through Microsoft Teams, etc.

FIG. 2 depicts a flow diagram of method 200 of one preferred embodiment of the present invention. Method 200 demonstrates how a preferred embodiment is capable of handling both structured feedback and unstructured feedback and centralizing these diverse feedback types in a singular system.

In step 205 of method 200, a submitting user begins the process of submitting structured feedback. To begin, the submitting user navigates to a network-enabled interface endpoint of the present system. In a preferred embodiment, this endpoint is a graphical interface that the user accesses through a website, a native (installed) software application, and/or a mobile application. In one operative scenario, a user submits structured feedback by following the system's instructions in step 210. The instructions provided by the system can include one or multiple questions or prompts delivered by the interface wherein each prompt is asking the user to take and action and/or submit an input. These inputs can take many forms, such as discrete options (like multiple choice questions), open-ended text inputs, numerical inputs, photographic or visual inputs, audio inputs, video inputs, and so on.

In one embodiment of method 200, a submitting user would be allowed to submit structured and/or unstructured feedback without first registering with or signing up to the system. In this scenario, both endpoint 205 and endpoint 220 would be publicly accessible and would allow any employee to share feedback at any time. This embodiment would allow feedback sharing at organizations that have not signed up for and/or purchased the rights to use a feedback system. This envisioned scenario can serve multiple benefits to employees that wish to share feedback but who may not have access to the tools to do so. For example, if an employee desires to share critical feedback about the employee's organization anonymously but the organization does not have an anonymous feedback system in place, this employee may not be able to share the desired feedback by using embodiments of the present invention that allow public access to the feedback endpoints as described herein. By having endpoints 205 and/or 220 publicly accessible to employees without prior registration from the employee or the employee's organization, the above-mentioned example can be avoided by simply allowing all employees to use the feedback system without prior registration.

In an embodiment of method 200 where endpoints 205 and/or 220 are publicly accessible for feedback submission without prior registration, an additional step 280 can be included in a preferred embodiment of method 200. This additional step 280 serves the purpose of verifying the submitting user's identify if the submitting user isn't previously known (and verified) to the system. The inclusion of step 280 is intended to prevent the feedback system from internalizing and storing feedback with an incorrect identity of the submitting user, regardless of whether the submitting user entered an erroneous identity maliciously or not.

One embodiment of the system can verify a user's identity by associating the user's identity with their email address. Such identity association is a common practice because email addresses are unique identifiers by design. In one embodiment, the operative completion of step 280 can be accomplished by sending the submitting user a unique verification code to the email address presented by the user as their identity. Then to complete step 280, the submitting user would need to present the verification code that was sent to the submitting user's email address. Once the submitting user has produced the correct verification code, the system can verify the submitting user's provided email address. While sending the submitting user a unique verification code and requesting said user to produce the same code is one implementation of an identity verification step 280, it should be noted that identity verification can be accomplished in a number of common industry methods without reducing the efficacy of said identity verification. For example, step 280 could be accomplished using the industry standard single sign-on (SSO) practice. Additionally, method 200 can feasibly and safely accomplish the same desired result with the identity verification step 280 occurring in a variety of sequences in the process flow of method 200. For example, the identity verification 280 can reasonably occur at any point between the beginning and the end of the process described in method 200 and still accomplish the same result. For clarity, all permutations of method 200 that alter the order and placement of step 280 have not been shown here. However, it should be noted that the present invention includes additional embodiments of method 200 where the method and placement of step 280 can be changed and/or removed as described herein.

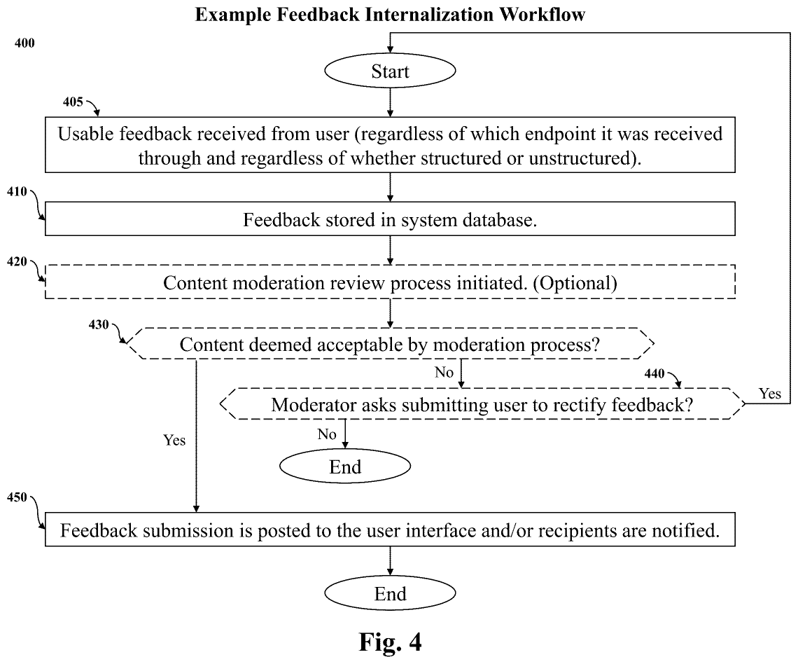

Once the user has submitted all of the required inputs in step 210 and the identity verification has completed in step 280, the system internalizes the feedback in step 290 and the submission process ends. One preferred embodiment of the process for internalizing feedback in step 290 is described in FIG. 4. In the scenario where an embodiment of the system does not include an identity verification step 280, the conclusion of the structured feedback submission in step 210 can be directly followed by the internalization process in step 290.

In step 220 of method 200, a submitting user begins the process of submitting unsolicited and unstructured feedback. In one embodiment, the user begins sharing unstructured feedback by initiating an inbound electronic communication with a network-enabled endpoint in step 220. Embodiments of the present invention can utilize a variety of network enabled communication endpoints to accomplish step 220. For example, step 220 in preferred embodiments of the present invention can receive unsolicited, unstructured feedback by allowing a submitting user to send a Short Message Service (SMS) text message, a Multimedia Messaging Service (MMS) text message, an electronic mail (email) message, an audio phone call, a message delivered through Slack (a communication application published by Slack Technologies, LLC) and/or a message delivered through Microsoft Teams (a communication application published by Microsoft Corporation) to an address of such medium that is associated with the present system.

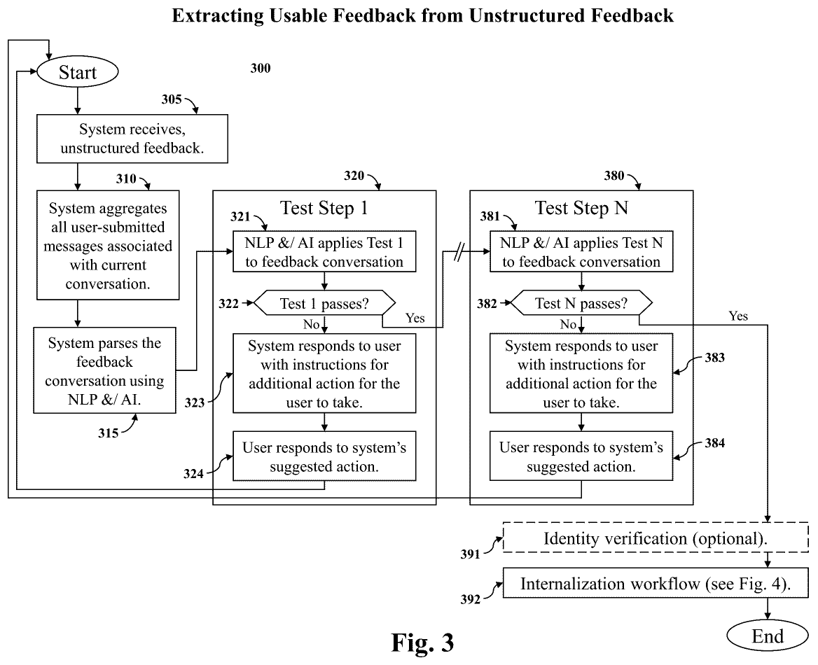

Then in step 230, the feedback handling system attempts to extract usable feedback from the unsolicited, unstructured feedback submitted by the user. A preferred embodiment of the process for attempting to extract usable feedback from unstructured feedback is further described in FIG. 3. There are a variety of reasons why unsolicited, unstructured feedback would be unusable to an organization. For example, the unstructured feedback could be incomplete and/or it could violate an organization's rules around information sharing. If step 240 deems that the user's unstructured feedback is usable, the system proceeds to steps 280 and 290 in a similar fashion as in the case of the structured feedback. If the system does not include an identify verification step 280, the usable feedback arising out of step 240 can then be internalized directly in step 290. As with the structured feedback, alternate embodiments of method 200 can accommodate alternate methods and sequential placements of step 280 in the unstructured feedback submission workflow without compromising the safety and integrity of method 200. Accordingly and as discussed previously, the present invention is not limited to the specific method of, inclusion of, and/or placement of step 280 in method 200.

In the event that the system's attempt to extract usable feedback from the unstructured feedback 230 results in no usable feedback in step 240, the system undergoes an iterative process 250 to engage with the submitting user and rectify any identified issues. A preferred embodiment of this iterative process 250 is described in greater detail in FIG. 3. A preferred embodiment described in FIG. 3 of method 300 demonstrates how unusable feedback results in the submitting user being prompted to provide additional information, thereby contributing additional unstructured feedback and thus repeating the process. This iteration results in step 250 rerouting a user to the beginning of method 200 through endpoint 220. In alternate embodiments of the present invention, step 250 could request that the submitting user take additional action in one or multiple alternate endpoints (as opposed to submitting additional information through the same medium as the original unsolicited submission in step 220).

In the handling of both structured and unstructured feedback, there are common data elements that are captured from the user. In a preferred embodiment of the system, step 290 stores the identity of the feedback's submitting user, the feedback's message itself, and/or the recipient of the feedback message. There are countless forms that the feedback received in method 200 can accommodate, and the present invention does not restrict an organization or a user to sharing and/or receiving a singular type of feedback. For example, embodiments of the present invention can collect one or multiple fields related to the feedback's message itself. Additionally, the system may collect metadata related to the feedback, such as the relationship between the submitting user and the feedback's recipient, the submitting user's position within the organization, the recipient's position with the organization, the date and time of the submission, and so on. While there are countless fields, prompts, questions, and inputs that can be collected in the feedback ingestion of method 200, the present invention is capable of accommodating these variations by adjusting the system's instructions in step 210 and the iterative interaction described in method 300 of FIG. 3 (with such method 300 utilized in steps 230-250). Accordingly, the present invention is not limited to a specific set of prompts or questions, but rather includes the flexibility to accommodate a multitude of desired questions, topics, fields, and prompts to be collected in a feedback submission (whether structured or unstructured).

Importantly, a preferred embodiment of the system allows the receipt of structured and unstructured feedback in method 200 to ultimately result in both types of feedback being internalized in the same system in step 290. In order to allow this centralization in a single database, steps 230-250 involve parsing and mapping the unstructured feedback to identify common attributes and fields of the unstructured feedback which are similarly present in the structured feedback submission in step 210. As is referenced in FIG. 2, this parsing and mapping in steps 230-250 is further described in FIG. 3. Allowing structured and unstructured feedback to be internalized in the same system provides benefits to the employee and the organization. This described method enables users to submit feedback in whichever method or medium is most convenient for them while still capturing and handling all feedback in a single system for convenient use by the organization, its managers, and/or its employees.

Embodiments of the present invention can also allow a submitting user to submit feedback that will be rendered anonymously by the system. Submitting feedback anonymously can provide multiple benefits to the submitting user and/or their organization. For example, the protection of anonymity can enable a submitting user to share feedback with less fear of retaliation against the submitting user that could result from the feedback submission. A preferred embodiment of the present system can record feedback identifiably (e.g. by recording an identity attribute of the user, such as their email address) but display the same feedback either identifiably or anonymously, depending on a multitude of conditions and preferences. Alternate embodiments of the system can omit the anonymity option and/or record feedback anonymously (e.g. not record any identity attributes of the submitting user).

FIG. 3 depicts a flow diagram of method 300 of a preferred embodiment where such method is an iterative process for extracting usable feedback from unstructured feedback. To begin the process, step 305 receives unstructured feedback from a submitting user.

The unstructured feedback in step 305 can originate from a plurality of network-enabled endpoints capable of receiving free-form communication. For example, incoming feedback in step 305 may arrive in a Short Message Service (SMS) text message, a Multimedia Messaging Service (MMS) text message, an electronic mail (email) message, an audio phone call, a message delivered through Slack (a communication application published by Slack Technologies, LLC), a message delivered through Microsoft Teams (a communication application published by Microsoft Corporation), a message delivered through Discord (a communication application published by Discord Inc.) and/or a message received by a chatbot affiliated with the feedback system of the present invention. The term “chatbot” used herein refers to an interactive computer application that simulates a human conversation, whereby a user enters into an interactive dialogue with an electronic communication application.

In a preferred embodiment, step 305 is capable of receiving both unsolicited feedback and solicited feedback. For example, unsolicited feedback may enter step 305 if a user initiates a communication with the feedback system without prior instruction to do so. As another example, step 305 can also receive solicited feedback if the user is providing information in response to a system request originating from a later step in method 300. This instance of a user submitting additional information in response to a system request is described later in this disclosure.

Allowing a submitting user to share unsolicited, unstructured feedback provides several benefits to the submitting user. One benefit of such method is that it allows a submitting user to use one (or multiple) communication application(s) that the submitting user may already have access to (such as electronic mail (email) or SMS text messaging), thereby eliminating the need for the submitting user to access an additional application to share feedback. Another benefit is an improved user experience for the submitting user. Specifically, sharing feedback in an unsolicited free-form communication with the feedback system can be more intuitive and easier to use than a conventional feedback system that may require the user to access a separate application and submit a survey or a form to share feedback.

In step 310, the system aggregates all messages that the user has submitted as part of the current conversation. By collecting and aggregating multiple messages associated with a singular feedback submission, the system is able to compile feedback across multiple interactions between the system and the user. This aggregation is needed to create a cohesive feedback submission following a possible interaction with the user following the tests of method 300 (described below). Instead of subjecting a singular unstructured message to the tests of method 300, step 310 is able to form a feedback entry from multiple messages, thereby enabling the capability of subjecting a multi-message submission to the ensuing tests (as opposed to a singular message). The benefit of allowing an unstructured feedback submission to comprise multiple messages is that it gives the submitting user the possibility of rectify any identified issues arising from the ensuing tests (as described in detail below). For the purposes of this disclosure, the phrase “feedback conversation” means an unstructured feedback submission comprising one or multiple messages from a submitting user. Alternate embodiments of method 300 can exclude step 310 and thereby subject the present feedback from step 305 to the ensuing tests.

In a preferred embodiment, step 310 can exclude prior feedback conversations from the present feedback submission. Excluding prior submission from the present feedback conversation can help isolate the present topic and prevent two or more submissions from being conflated or inadvertently merged by the system. As an operative example, step 310 can exclude prior feedback conversations that resulted in the submission being abandoned. There exists a variety of reasonable methods that could be implemented to perform the exclusion of prior feedback conversations. In one embodiment, step 310 can exclude all prior feedback conversations that have resulted in said prior submission being stored and internalized. In another embodiment, step 310 could impose a time restriction on the feedback conversation. In the example of a time restriction being imposed, the system can exclude all prior unstructured feedback from the present submission if such prior unstructured feedback was received before a certain time (e.g. 60 minutes prior to the present, for example).

Additionally, the situation may arise wherein a submitting user abandons a feedback submission. For example, if the system requires additional action from the user (as described in the ensuing steps below) and the submitting user fails to undertakes such required action, one preferred embodiment can deem the present submission as abandoned. In one embodiment, step 310 can deem feedback as abandoned if such feedback conversation does not result in said feedback being stored and internalized within a window of time (e.g. 60 minutes, for example). In this embodiment, step 310 can exclude the abandoned submission from inclusion in future feedback conversations. In alternate embodiments of the present invention, when the situation arises where a submitting user fails to undertake a required or suggested action provided by the system, the system can proceed to store and internalize the present feedback despite such submission having a known problem. In this situation, alternate embodiments can include additional steps to rectify a known problem, such as a subsequent content moderation process to address any potential issues with the feedback.

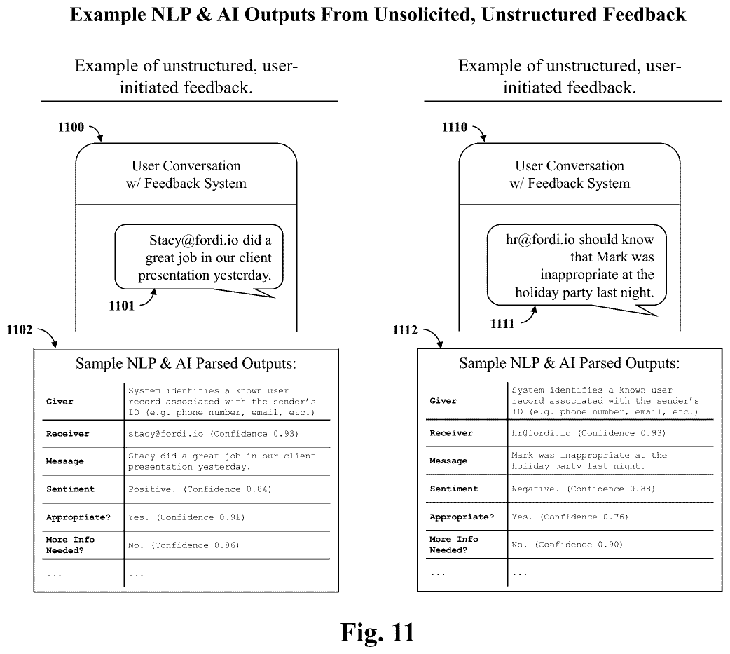

In step 315, the system parses the current feedback conversation using natural language processing (NLP) and/or artificial intelligence (AI). This parsing maps the unstructured (free-form) feedback conversation against a set of expected and/or required fields so that the unstructured feedback can be stored in a structured database. In one embodiment, the NLP parsing in step 315 attempts to identify a submitting user, a feedback message, and a recipient of the feedback. Alternate embodiments can attempt to parse countless other fields, including both content-driven parsing (e.g. extracting data from the communication's content) as well as parsing metadata (such as the date of the submission). Additionally, the parsing can be generalized and attempt to identify standard attributes that would be expected in all feedback and can also be customized, such as incorporating the parsing of organization- and/or user-specific attributes. Illustrative outputs arising from step 315 are included in tables 1102 and 1112 of FIG. 11 (later in this disclosure).

Following step 315, the system subjects the current feedback conversation to zero, one, or multiple tests. In a preferred embodiment with at least one test, the feedback conversation is subjected to a first test step 1 320. As discussed herein, the terms “test” and “test step” are used interchangeably. Step 321 the use of natural language process (NLP) and/or artificial intelligence (AI) to parse and analyze the feedback conversation. The purpose of a test step is to ascertain whether the feedback conversation contains one or multiple pre-defined and required attributes. One preferred embodiment can employe NLP and/or AI to perform a given test. A particular test step will “pass” if the feedback conversation satisfies all of the present test step's required attributes and it will “fail” if the feedback conversation does not satisfy all of the required attributes. This binary decision is contemplated as a first example in step 322.

Embodiments of the present invention can implement step 321 using natural language processing (NLP) and/or artificial intelligence (AI) using one or multiple commercially-available industry standard tools and/or large language models (LLM). For example, step 321 could be accomplished using the GPT-4 AI LLM (published by affiliated entities of OpenAI LP) and/or the Llama 2 AI LLM (published by affiliated entities of Meta Platforms, Inc.). Such analysis and parsing can be accomplished in a variety of languages, including Javascript and/or Python, among others. Alternative embodiments of the present invention can also incorporate a proprietary LLM or NLP method that is developed organically and/or is adapted from an existing commercially-available NLP model or LLM. For example, alternate embodiments can reflect the “training” of one or multiple commercially-available LLMs or NLP methods based on desired attributes of the present system. For the present disclosure, “training” refers to the refinement of a LLM or NLP method by using an existing dataset to increase the likelihood of a the LLM or NLP to result in the desired output.

The purpose of inserting tests into method 300 is to enable the system and the user to rectify a problematic feedback submission. In an alternate embodiment of the present invention, method 300 could be reduced by eliminating all test steps and storing the parsed, unstructured feedback with no attempt to rectify the feedback conversation in any manner. In such an embodiment, any problematic feedback could be later rectified (such as with a content moderation process that could alert the submitting user of a required action if needed, for example). While this alternate embodiment could achieve a similar outcome, a preferred embodiment of method 300 allows the system and the user to rectify any known issues at the point of submission, thereby eliminating a need for the system or the user to revisit the feedback submission to rectify an issue that could have been corrected using the preferred embodiment of method 300.

The test steps in method 300 can include a variety of required attributes. The nature of the tests in method 300 can be general in nature and/or they can be customized to a specific user and/or organization's needs or preferences. Generalized tests can be imposed in an attempt to rectify potential issues that would apply to many types of feedback and/or multiple users and/or multiple organizations. Example general test steps include testing whether the feedback is complete, whether it's appropriate in nature (for the workplace), and/or whether it's given in the appropriate format (such as in whether it's received in an accepted language, for example). In practice, there are countless generalized test steps that can be implemented in alternate embodiments of the present invention and the examples included in this disclosure are intended to illustrate one potential implementation of method 300. In an illustrative example, an example of an incomplete feedback conversation would be one where the parsing in step 315 is unable to identify a giver, a feedback message, and/or a recipient. As another illustrative example, another general test step can measure whether the feedback conversation contains inappropriate or unprofessional feedback. Additionally, alternate embodiments of the system can be configured to include organization-specific test steps. In this situation, the system would have prior knowledge of an organization's required test steps and would implement such test steps in method 300 to apply to feedback related to that organization.

Continuing with a first example test step 320, in the event that step 322 results in test failure (with this disclosure's definition of test failure defined above), method 300 attempts to rectify the present feedback submission to become compliant with the present test step. In this situation where the present test step fails, step 323 comprises the system providing a response to the submitting user where the system's response includes instructions for the submitting user to rectify their submission. Such user's response to the system is captured in 324 of method 300.

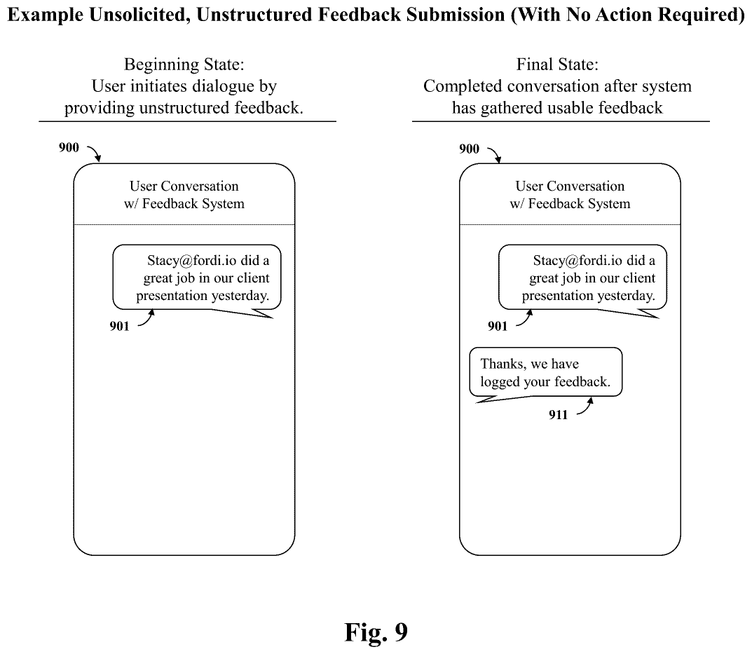

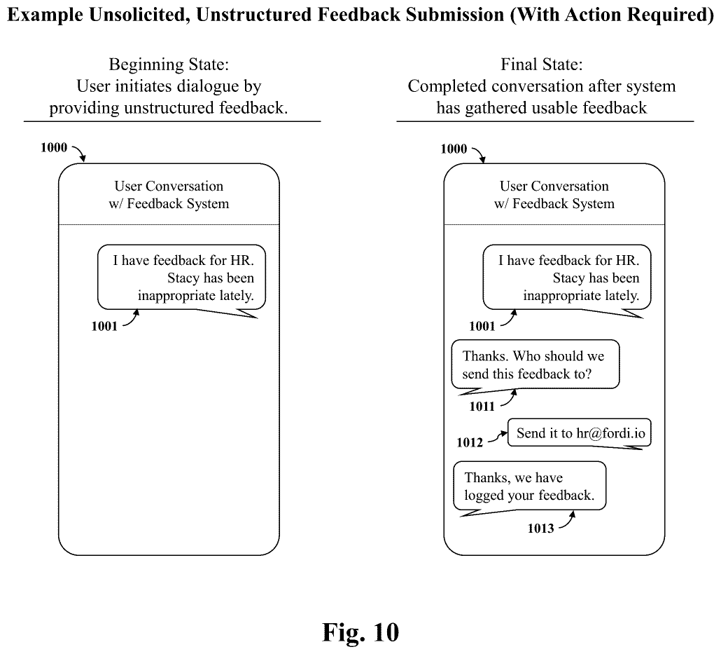

In a preferred embodiment, step 323 initiates a conversational dialogue with the submitting user, wherein the system's instructions in step 323 attempt to replicate a conversation in natural language. In this preferred embodiment, the exchange of messages occurs in the same communication endpoint as the initial unstructured feedback message of the present feedback conversation. Additionally, in this preferred embodiment, the system's responses are inviting additional unstructured information from the submitting user. Such conversational dialogue can happen synchronously and/or asynchronously. For example, in such a conversational dialogue, the system's response in step 323 can ask the user a question such as “Who should we be sending this feedback to?” and wherein the system will expect an unstructured text response from the user. This example question is purely illustrative in nature since step 323 can result in countless possible responses to the submitting user (depending on the nature of the present feedback conversation, the configuration of the tests, etc.). This preferred embodiment can result in an intuitive and inviting user experience for the submitting user, where the feedback submission conversation will be similar to a natural language conversation with a human, for example. Illustrative and operative examples of conversational dialogues utilizing embodiments of method 300 to receive and/or rectify an unstructured feedback submission can be seen in FIGS. 9 and 10.

To create a natural language response 323 in embodiments of method 300 that form a conversational dialogue with the submitting user, method 300 can utilize an artificial intelligence (AI) system. To form a system response 323 using AI, the AI system can be given the present feedback conversation (as aggregated in step 310, for example) and can also be provided with the requirements of the present test step. The AI system can then produce a natural language response to the user in an effort to rectify the feedback conversation to become compliant with the present test. Many commercially-available AI systems can accomplish this exercise without undue experimentation. For example, AI systems that can accomplish this task include the GPT-4 AI (published by affiliated entities of OpenAI LP), the Llama 2 AI (published by affiliated entities of Meta Platforms, Inc.), a proprietary AI system, an AI system that is adapted from or trained on an existing commercially-available AI system, etc. There are countless AI systems and large language model (LLM) systems that are available today that can implement this exercise within any given test step. Additionally, embodiments of method 300 can include the use of multiple AI systems in various test steps and in a multitude of configurations.

In alternate embodiments, the system can provide instructions for the user to undertake step 324 through another endpoint of the system. For example, a response 323 can instruct the user to navigate to a user interface outside of the present endpoint through which the submitting user submitted the first piece of unstructured feedback in the present feedback conversation. As an illustrative example, if the user initiates an unstructured feedback submission through an email message, the system can direct the submitting user to complete the present feedback submission in a user interface of the system, such as through a website. Additionally, alternate embodiments can accommodate additional user action 324 being structured.

Subsequently, the user's response in step 324 results in the submission of additional information in the present feedback conversation and thereby repeats the process of method 300 from the beginning (as illustrated in FIG. 3). In this repeating action, method 300 now begins the process of subjecting the present feedback conversation to its test steps but with the inclusion of the additional information provided in step 324.

Method 300 can include zero, one, or multiple test steps. The present disclosure refers to the number of test steps in method 300 as “N” steps, wherein the use of the N nomenclature signifies that the number of test steps is variable (and can be zero, one, or multiple). For the sake of clarity in FIG. 3, the variability of the number of test steps has been demonstrated as a first example test step 320 and a last example test step 380, though it's understood that the visualization of the process flow diagram in FIG. 3 generalizes a method 300 that can have zero, one, or multiple test steps. The iterative nature of method 300 reflects a similar process flow from one test step to the subsequent test step, as described herein. Embodiments of method 300 that include no test steps (i.e. N=0) would result in step 315 being followed directly by step 391. Embodiments of method 300 that include a singular test step (i.e. N=1) would result in the Yes result from step 322 being followed directly by step 391. Embodiments of method 300 that include two test steps (i.e. N=2) would result in the Yes result from step 322 being followed directly by step 381. Embodiments of method 300 that include more than two test steps (i.e. N>2) would result in the inclusion of additional test steps after test step 320 and in the same general structure as test step 380. Specifically, in this situation where N>2 in method 300 of FIG. 3, the Yes result from a present test step N−1 would result in the initiation of a subsequent test step N. Specifically, a Yes result from test step N−1 would result the first step of the subsequent test step N, specifically the performance of NLP and AI parsing and analysis of test step N. This process flow of the present test's passing resulting in the subsequent test being initiated is visualized in FIG. 3 as the Yes result from step 322 leading to step 381 (with the dashed line in this specific process flow indicating the potential inclusion of additional, interim test steps where N>2).

As described above, once step 322 results in a Yes (meaning that the present test step has passed), the subsequent test step is initiated. The first step of a subsequent test step (e.g. 381) undergoes a similar process as step 321, albeit measuring a different pre-defined, required attributes in the present test step that is different than in prior test steps. The ensuing steps of the present test take a similar process flow as the first example test step 320. Should the present test fail (as in step 382), the system responds to the user with instructions for user action in step 383 in much the same form as 323 from the first example test step, albeit with potentially different instructions than were given in prior test steps. Consequently, the user can respond with additional information in the present test step (as in step 384) and begin method 300 again in much the same form as step 324 of a first example test step 320.

Once all of method 300's test steps have passed and all of the pre-defined, required attributes of the feedback conversation have been satisfied, the system can verify, store, and internalize the feedback. Specifically, the Yes result from the final test step (as in the Yes result of step 382 of the final example test step 380) can lead to step 391. A preferred embodiment of method 300 includes step 391 to verify the submitting user's identity as an added security measure. For example, the system can send a unique verification code to the user in an alternate medium than the present medium being used for the present feedback conversation. Once the user provides the unique code, the system can verify their identity. Alternate embodiments of method 300 can include alternate methods of identify verification, such as industry-standard single sign-on (SSO). Alternate embodiments of the present invention can also exclude an identity verification step 391 if desired. Furthermore, alternate embodiments of the present invention can incorporate an identity verification step 391 at any point in the process, specifically at any point in method 300 between the beginning and ending of the process.

If an identity verification step 391 is included in the location specified in FIG. 3, its successful completion will result in the final step 391 being initiated, the feedback internalization workflow (which is further described in method 400 of FIG. 4). In alternate embodiments where an identity verification step is not included in method 300, the Yes result from the final test step will trigger step 392, the internalization workflow. In alternate embodiments where an identity verification step occurs elsewhere in method 300, the successful completion of the identity verification step will trigger the subsequent workflow as currently depicted in FIG. 3.

FIG. 4 depicts a flow diagram of a preferred embodiment of method 400, the process to internalize and store a feedback submission. Method 400 begins with begins with the receipt of usable feedback being received from a user, regardless of which endpoint it was received through and regardless of whether this usable feedback is structured or unstructured (step 405). Feedback in step 405 is deemed usable if it is able to be stored by the system. For example, structured feedback received (e.g. by step 210 of method 200 in one preferred embodiment) can be usable because it is received in a pre-defined format as determined by the system and the system's associated interface through which a submitting user can submit feedback. Unstructured feedback can be useable once it has undergone natural language processing, artificial intelligence analysis, and/or a series of tests (such as by method 300 in one preferred embodiment).

Subsequently, the usable feedback is stored in the system's database in step 410. The system can utilize the natural language processing and/or artificial intelligence analysis of method 300 to map unstructured feedback to a set of pre-defined data fields to enable the storage in step 410. In one embodiment, this set of pre-defined data fields can include the feedback's submitting user, the feedback message, and the recipient. Alternate embodiments of the present invention can include countless other combinations of pre-defined fields including content-driven fields (that are based on the content of the feedback) as well as metadata-driven fields (such as the time of entry, for example). One skilled in the art can implement step 410 using a variety of different systems and methods. For example, embodiments of method 400 could store feedback in step 410 using one or multiple instances of a Microsoft SQL Server database (a database infrastructure published by Microsoft Corporation), a MySQL database (published by a consortium of developers including Oracle Corporation), abstractions thereof, and/or alternative databases and/or data storage systems and apparatuses.

One preferred embodiment of method 400 includes a content moderation process. A content moderation process can help ensure safe and professional use of the feedback system. For example, if a malicious submitting user is attempting to bully or harass another user, this submitting use could share inappropriate and harmful content through the present system. A content moderation process in method 400 can be an effective way to prevent this malicious content from ultimately being delivered to a recipient and causing harm. Alternate embodiments of method 400 can exclude a content moderation process. In such a situation where embodiments of method 400 exclude a content moderation process, the completion of the storage procedure in step 410 is directly followed by the delivery step 450.

In embodiments of method 400 that include a content moderation process, the completion of the storage step 410 initiates the content moderation process 420. The content moderation process can be accomplished by a human, a system, or a combination thereof. Including a system in the content moderation process can help improve the scope, accuracy, and latency of a human content moderator. For the purposes of this discussion, the term “moderator” will be understood to be a human, an automated electronic moderation system, or a system that handles content moderation by combining an automated electronic system with a human moderator. In step 420, the moderator is notified of a new piece of feedback requiring review. In step 430, the moderator decides whether the present feedback is acceptable. Such decision of whether the feedback is acceptable can be made on a general basis (e.g. using judgement intended to apply to diverse feedback and/or feedback associated with multiple organizations) and/or on a specialized basis (e.g. using judgement adapted to the use case of a particular user, organization, sector, industry, etc.). Once the feedback is deemed to be acceptable in step 430, step 450 is initiated wherein the feedback submission is posted to the system's user interface and/or the recipients are notified.

Additionally in step 450, preferred embodiments of method 400 can include the capability of notifying one or multiple recipients of a new feedback submission. For example, embodiments of method 400 can notify the recipient of a particular feedback submission via one or multiple communication methods (e.g. electronic mail (email), a push notification on a computer or mobile device, etc.) Additionally, preferred embodiments of the system can also include the ability to post notifications to a pre-defined group of users through one of multiple integrations with communications services that enable such group communication. For example, a preferred embodiment of method 400 can allow an organization to configure the present system to be able to post certain types of feedback to group communications hosted on Slack (a communication application published by Slack Technologies, LLC), Microsoft Teams (a communication application published by Microsoft Corporation), Discord (a communication application published by Discord Inc.) and/or a chatbot affiliated with the feedback system of the present invention (amongst others). Additionally, embodiments of the present method can also notify the submitting user of the successful completion of their present submission.

In the event that step 430 of the content moderation process does not deem the present feedback submission as being acceptable, a moderator can decide whether or not the moderator will ask the submitting user to rectify their feedback to become acceptable by the moderator (step 440). For example, a moderator may ask a submitting user to rectify their feedback if the moderator deems that the present feedback submission's noncompliance with the moderation process is a result of a good-faith effort. Alternatively, the moderator may decide not to ask the submitting user to rectify their feedback if the present feedback submission is malicious in nature. If step 440 does not result in the moderator asking the submitting user to rectify their feedback, the present submission process terminates and the present feedback submission is abandoned and rendered inaccessible in the system's user interface. Alternatively, if step 440 results in the moderator asking the submitting user to rectify their feedback, the moderator can provide instructions for the submitting user to adjust their submission to become compliant with the content moderation process and the internalization workflow 400 is re-initiated upon receipt of an adjusted feedback submission.

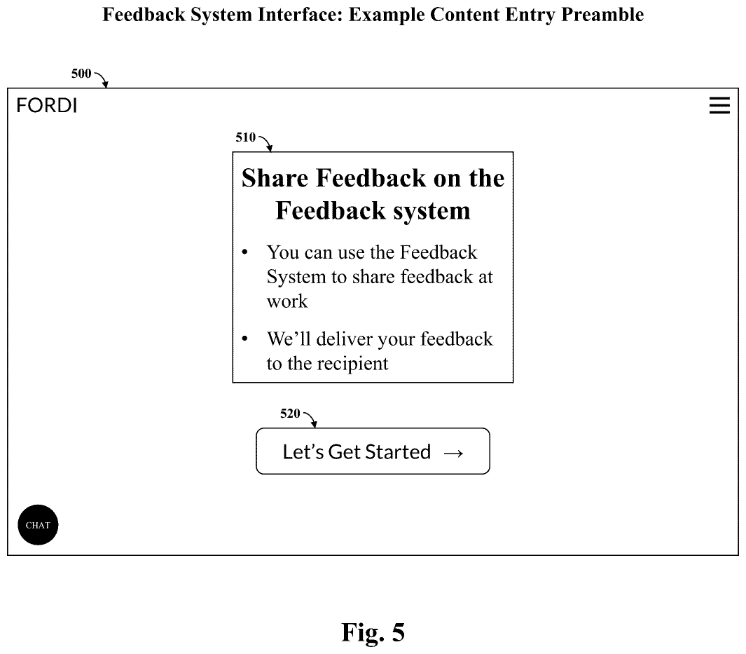

The system's user interface allows users to interact with feedback submissions. Examples of the system's user interface are described in FIGS. 5-11 in this disclosure. The user interface includes the capability for a submitting user to submit feedback as well as view and interact with existing feedback submissions. Preferred embodiments of the present system can include customizable permissions and restrictions that can limit certain users' ability to interact with certain types of feedback. For example, preferred embodiments can include the ability for an organization to implement a limitation such that only certain users (e.g. human resources professionals) can interact with certain feedback.

FIG. 5 depicts a first example interface screen of one embodiment of the system adapted for use with the present invention, with such interface screen greeting a user that's preparing to submit feedback. The user screen 500 can be accessed from a plurality of network-enabled endpoints. For example, embodiments of the present invention can allow users to access the user interface from a web browser or through a native (installed) software application. Additionally, embodiments of the present invention can include user interfaces that are accessible from desktop computers, laptop computers, mobile devices, smartphones, tablet computers, wearable devices, and other network-enabled apparatuses (such as smart speakers, for example). A preferred embodiment of the present screen includes a preamble 510 that greets a submitting user with context around their potential feedback submission. For example, this preamble can include context around how long the submission is expected to take, who will be notified of the feedback, whether a login or sign-up is required, how much the submission will cost the user, and so on. Such preamble can benefit a user submitting unsolicited feedback in the event that the submitting user is unfamiliar with the usage of the present invention and has been referred to the present system without full context of the system's usage. The user can then confirm their understanding of the preamble by clicking on button 520 to advance in the process of submitting feedback.

FIG. 6 depicts a second example interface screen of one embodiment of the system adapted for use with the present invention, with such interface screen showing a pre-defined prompt in a structured feedback submission. The user screen 600 is in a similar form of and can be accessed in the same ways as the user screen 500 of FIG. 5. This screen is centered around a user prompt 610 (e.g. a question, instruction, etc.). If the prompt 610 could invite a follow-up question on behalf of the user, one embodiment could include a clarification 611 that attempts to address a user's potential questions. For example, if a user could question why a prompt 610 is being asked of the user, a clarification 611 can be clicked to unveil clarifying text around the purpose of such prompt. While clarification 611 isn't necessarily a vital element of such screen, embodiments of the present invention can include clarifications akin to 611 of this figure to help improve the submitting user's experience and aid in their understanding of the feedback system in general. Input field 620 allows a user to enter their response to prompt 610, and such input fields can be configured to accept diverse inputs including text, numbers, images, video, audio, etc. Illustrative instruction 630 instructs a user how to advance to the next part of the submission process.

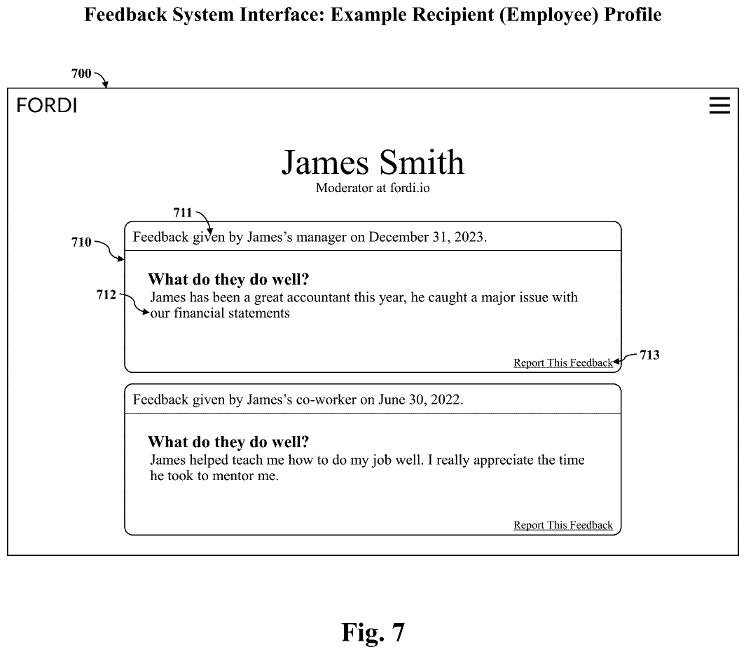

FIG. 7 depicts a third example interface screen of one embodiment of the system adapted for use with the present invention, with such interface screen aggregating feedback submissions related to an identified individual. The user screen 700 is in a similar form of and can be accessed in the same ways as the user screen 500 of FIG. 5. Feedback instances 710 and 720 display feedback system that's been received and internalized by the feedback system of the present invention. Within feedback instance 710, embodiments of the present system can include the display of metadata, such as field 711 which provides context around the relationship of the submitting user to the recipient as well as the date of submission. Field 712 includes the feedback message itself. Button 713 allows a viewing user to interact with the feedback, in this case by reporting it for review to the moderators. Alternate embodiments of the present screen can allow a user to view, edit, remove, amend, and/or re-order stored feedback.

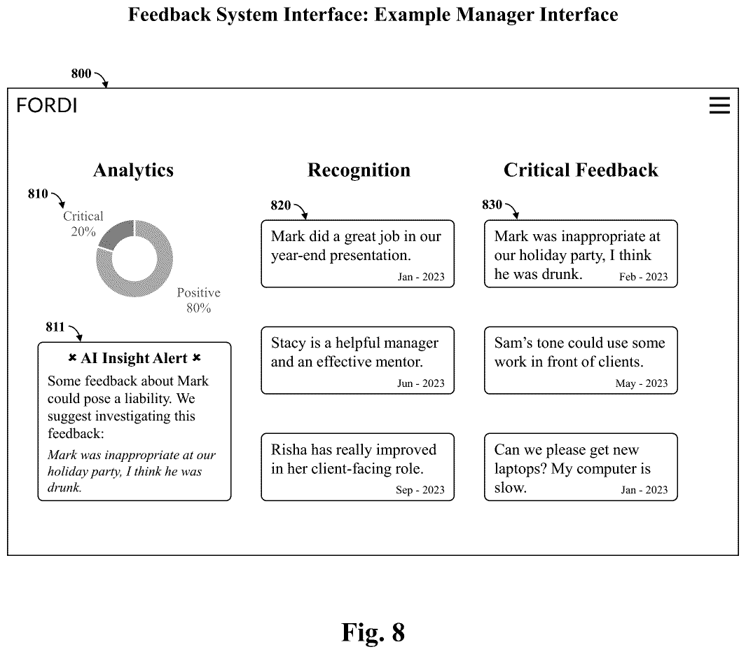

FIG. 8 depicts a fourth example interface screen of one embodiment of the system adapted for use with the present invention, with such interface screen demonstrating an example analytics view intended for a manager or human resources professional. The user screen 800 is in a similar form of and can be accessed in the same ways as the user screen 500 of FIG. 5. Such screen in FIG. 8 shows one embodiment of an analytics dashboard that can be utilized by a manager and/or a human resources professional. Embodiments of such analytics dashboards can include analytics charts, tables, and figures (such as an example donut chart 810). Additionally, embodiments of the present user interface can utilize artificial intelligence (AI) to analyze feedback. For example, such analysis can identify themes, trends, risks, outliers, noteworthy individuals, noteworthy submissions, etc. As an operative example in the present screen, AI insight 811 identifies a sample piece of feedback that such AI has flagged as a potential liability for the organization and/or an individual user. Additionally, such manager interface can aggregate feedback that pertains to a viewing user. Embodiments of the present feedback system can also segment feedback into different categories such as by sentiment. For example, feedback 820 has been designated as affirmative (positive recognition) while feedback 830 has been dedicated as critical in nature.

FIG. 9 depicts a first operative example of an unsolicited, unstructured feedback submission in one embodiment of the system adapted for use with the present invention, with such example showing an example submission of unsolicited, unstructured feedback in a synchronous dialogue between the submitting user and the system and where the system requires no additional action on behalf of the submitting user. Interface 900 can be accessed through a one or multiple network-enabled communication endpoints, such as a web browser window or a native (installed) application. Furthermore, interface 900 can be accessed through network-enabled communication endpoints such as a Short Message Service (SMS) text message, a Multimedia Messaging Service (MMS) text message, an electronic mail (email) message, an audio phone call, a message delivered through Slack (a communication application published by Slack Technologies, LLC), a message delivered through Microsoft Teams (a communication application published by Microsoft Corporation), a message delivered through Discord (a communication application published by Discord Inc.) and/or a message received by a chatbot affiliated with the feedback system of the present invention. In the operative example of the present FIG. 9, a submitting user has initiated an unstructured feedback submission by sending the information in message 901 to a network-enabled endpoint associated with the feedback system. The left half of FIG. 9 shows the beginning state of the submission interaction, such as the interface immediately following the submission of message 901. The receipt of message 901 would initiate the methods adapted for use with the present system for handling unstructured, unsolicited feedback. For example, a preferred embodiment of the present invention can initiate method 300 upon the receipt of message 901. The right half of FIG. 9 shows user interface 900 in a final state, upon the completion of a successful feedback submission. In this operative example, the system has sent a confirmation message 911 to the submitting user to notify the user of the successful completion of the submission process.

FIG. 10 depicts a second operative example of an unsolicited, unstructured feedback submission in one embodiment of the system adapted for use with the present invention, with such example showing an example submission of unsolicited, unstructured feedback in a synchronous dialogue between the submitting user and the system and where the system requires additional action on behalf of the submitting user. The submission endpoint interface 1000 is in a similar form of and can be accessed in the same ways as the endpoint interface 900 of FIG. 9. In this this operative example interaction in FIG. 10, the system receives unstructured, unsolicited feedback from a user in message 1001. Upon processing the feedback in accordance with methods 200, 300, and 400, the system determines that additional action is required from the user. In this illustrative example, one of the test steps in method 300 could fail, wherein such failing test could measure for completeness and deem message 1001 incomplete because it does not include a unique recipient. In this operative example, the system responds to the user by sending message 1011 that requests the user to provide a recipient. The user responds to the system in message 1012 with additional information to address the requested action. In one preferred embodiment, the receipt of method 1012 initiates method 300 for a second time in this illustrative example, and the additional information provided in message 1012 results in all of the tests passing and the feedback submission proceeding to completion. Finally, the system confirms that the user's feedback submission is complete with message 1013. In practice and in alternate embodiments, method 300 can include countless tests against which a feedback submission and/or a feedback conversation is subjected.

While this illustrative example in FIG. 10 requests a user provide a follow-up related to the recipient, alternate operative use cases could deem message 1001 as complete or could request countless other actions from the submitting user. For example, an alternate embodiment of the feedback system could respond to the feedback in message 1001 by asking the user to provide an example of the subject's (Stacy's) allegedly inappropriate behavior.

FIG. 11 depicts a third operative example of an unsolicited, unstructured feedback submission in one embodiment of the system adapted for use with the present invention, with such example showing one embodiment of the desired output fields arising from the natural language processing (NLP) and/or artificial intelligence (AI) analysis from unstructured feedback. In this figure, the submission endpoint interfaces 1100 and 1110 are in a similar form of and can be accessed in the same ways as the endpoint interface 900 of FIG. 9. Upon receiving message 1101 (on the left side of FIG. 11), the system parses the message in accordance with methods 200, 300, and 400. As an operative example, table 1102 shows illustrative outputs arising from the natural language processing (NLP) and/or artificial intelligence (AI) analysis as described in the aforementioned methods. In one preferred embodiment of the present invention, tables 1102 and 1112 contain illustrative outputs arising from the execution of step 315 of method 300, for example.

In table 1102, a set of outputs identifies the giver, receiver, the feedback message, sentiment, whether the message is deemed appropriate for the workplace or not, whether the message requires additional information, and so on. The output fields in tables 1102 and 1112 are purely illustrative in nature and alternate embodiments of the present system could include or exclude countless other desired fields for the NLP and/or AI to attempt to populate. The outputs from the NLP and/or AI analysis can also include a confidence level for each output, and a preferred embodiment of the system can choose to discard certain outputs where such output's associated confidence level falls below a pre-determined threshold. Alternate embodiments can choose to exclude the confidence interval and/or not gather a confidence interval at all in the NLP and/or AI analysis.

As described earlier in the disclosure, methods 200, 300, and 400 can accommodate a variety of embodiments, endpoints, and content types as it relates to handling feedback. In alternate embodiments of the present interface and interactions of FIGS. 9-11, the interactions between the submitting user and the system can happen asynchronously and/or the system could direct the user to complete the submission process through a different endpoint (e.g. directing the user to navigate to a web page to collect more structured information, for example). Furthermore, the content of messages 901, 911, 1001, 1011, 1012, 1013, 1101, and 1111 as well as the results of the interactions in FIGS. 9-11 are purely illustrative. The substance and process of the feedback submissions are ultimately governed by the methods discussed earlier and the examples shown in FIGS. 9-11 are included in the disclosure for purely illustrative purposes.

What is claimed is:

1. A method implemented by an electronic feedback system, the method comprising:
a. providing at least one network-enabled endpoint, wherein an endpoint is capable of receiving unsolicited (user-initiated) feedback;
b. monitoring the network-enabled endpoints for feedback submissions; and
c. storing said feedback submissions in a data storage apparatus.

2. The method of claim 1, further comprising:
a. configuring the network-enabled endpoints to allow a feedback submission from a submitting user without requiring the submitting user to register to use the feedback system as a prerequisite of the feedback submission; and
b. configuring the network-enabled endpoints to allow the feedback submission from the submitting user without requiring the submitting user's organization to register to use the feedback system as a prerequisite of the feedback submission.

3. The method of claim 1, further comprising subjecting the feedback submissions to a content review process to reject or modify feedback that doesn't comply with one or multiple pre-defined rules governing acceptable feedback.

4. The method of claim 1, wherein one or multiple of the network-enabled endpoints is an electronic communication medium capable of receiving electronic messages and directing them to the feedback system.

5. The method of claim 4, further comprising parsing said electronic messages to enable the electronic messages to be stored as a feedback submission in the data storage apparatus.

6. The method of claim 5, further comprising:
a. subjecting the electronic messages to one or multiple tests, wherein a test measures whether the electronic messages comply with at least one pre-defined rule;
b. interacting with a submitting user in a rectifying interaction by providing one or multiple prompts to the submitting user, wherein the rectifying interaction is initiated in the scenario where one or multiple of the tests “fail” (namely, the electronic messages don't satisfy the pre-defined rule or rules of the present test) and wherein the rectifying interaction with the submitting user attempts to rectify the feedback submission to become compliant with the present test by requesting additional action or information from the submitting user; and
c. updating the feedback system's stored record of the feedback submission in the data storage apparatus, wherein said updating stores additional, incremental, corrected, or more current information provided by the submitting user in the rectifying interaction.

7. The method of claim 6, wherein the rectifying interaction between the feedback system and the submitting user is a conversational dialogue occurring through the same network-enabled endpoint that received the submitting user's initial electronic message and wherein the feedback system's responses to the submitting user are in conversational, natural language.

8. The method of claim 6, wherein one or multiple of the tests or rectifying interactions is conducted using natural language processing (NLP) or artificial intelligence (AI) technologies.

9. A feedback system comprising:
a. one or more processors;
b. a memory coupled to at least one of the processors; and
c. a set of computer program instructions stored in the memory and executed by at least one of the processors in order to perform actions comprising:
i. providing at least one network-enabled endpoint, wherein an endpoint is capable of receiving unsolicited (user-initiated) feedback;
ii. monitoring the network-enabled endpoints for feedback submissions; and
iii. storing said feedback submissions in a data storage apparatus.

10. The feedback system of claim 9, wherein the actions further comprise:
a. configuring the network-enabled endpoints to allow a feedback submission from a submitting user without requiring the submitting user to register to use the feedback system as a prerequisite of the feedback submission; and
b. configuring the network-enabled endpoints to allow the feedback submission from the submitting user without requiring the submitting user's organization to register to use the feedback system as a prerequisite of the feedback submission.

11. The feedback system of claim 9, wherein the actions further comprise subjecting the feedback submissions to a content review process to reject or modify feedback that doesn't comply with one or multiple pre-defined rules governing acceptable feedback.

12. The feedback system of claim 9, wherein one or multiple of the network-enabled endpoints is an electronic communication medium capable of receiving electronic messages and directing them to the feedback system.

13. The feedback system of claim 12, wherein the actions further comprise parsing said electronic messages to enable the electronic messages to be stored as a feedback submission in the data storage apparatus.

14. The feedback system of claim 13, wherein the system's actions further comprise:
a. subjecting the electronic messages to one or multiple tests, wherein a test measures whether the electronic messages comply with at least one pre-defined rule;
b. interacting with a submitting user in a rectifying interaction by providing one or multiple prompts to the submitting user, wherein the rectifying interaction is initiated in the scenario where one or multiple of the tests “fail” (namely, the electronic messages don't satisfy the pre-defined rule or rules of the present test) and wherein the rectifying interaction with the submitting user attempts to rectify the feedback submission to become compliant with the present test by requesting additional action or information from the submitting user; and
c. updating the feedback system's stored record of the feedback submission in the data storage apparatus, wherein said updating stores additional, incremental, corrected, or more current information provided by the submitting user in the rectifying interaction.

15. The feedback system of claim 14, wherein the rectifying interaction between the feedback system and the submitting user is a conversational dialogue occurring through the same network-enabled endpoint that received the submitting user's initial electronic message and wherein the feedback system's responses to the submitting user are in conversational, natural language.

16. The feedback system of claim 14, wherein one or multiple of the tests or rectifying interactions is conducted using natural language processing (NLP) or artificial intelligence (AI) technologies.
